(19) United States
(12) Patent Application Publication
(10) Pub. No.: US 2015/0324708 A1
(43) Pub. Date: Nov. 12, 2015

(54) ON-DEMAND TRANSPORTATION

(71) Applicant: Ford Global Technologies, LLC, Dearborn, MI (US)

(72) Inventors: David Skipp, Brentwood (GB); Will Farrelly, Chelmsford (GB); Douglas Nicoll, Chelmsford (GB); Jonathan Scott, Chelmsford (GB); Richard Brown, London (GB)

(73) Assignee: Ford Global Technologies, LLC, Dearborn, MI (US)

(21) Appl. No.: 14/669,524

(22) Filed: Mar. 26, 2015

Related U.S. Application Data
(60) Provisional application No. 61/988,989, filed on May 6, 2014.
(60) Provisional application No. 61/988,986, filed on May 6, 2014.
(60) Provisional application No. 61/988,987, filed on May 6, 2014.
(60) Provisional application No. 61/988,992, filed on May 6, 2014.
(60) Provisional application No. 61/988,990, filed on May 6, 2014.
(60) Provisional application No. 61/988,994, filed on May 6, 2014.

(51) Int. Cl. G06Q 10/02; H04W 4/02

(52) U.S. Cl. CPC G06Q 10/02; H04W 4/02; G06Q 50/30

(57) ABSTRACT

A user is detected in a vicinity of a shared transportation vehicle by identifying a user device and determining a location of the user device. Parameters are determined for user travel of a route of the shared transportation vehicle. A message is targeted to a device of the detected user based on a location of the detected user.

### RELATED APPLICATIONS

This application claims priority to Provisional Application Ser. No. 61/988,989 filed May 6, 2014 entitled “On-Demand Transportation”; Provisional Application Ser. No. 61/988,986 filed May 6, 2014 entitled “On-Demand Transportation”; Provisional Application Ser. No. 61/988,987 filed May 6, 2014 entitled “On-Demand Transportation”; Provisional Application Ser. No. 61/988,992 filed May 6, 2014 entitled “On-Demand Transportation”; Provisional Application Ser. No. 61/988,990 filed May 6, 2014 entitled “On-Demand Transportation”; and Provisional Application Ser. No. 61/988,994 filed May 6, 2014 entitled “On-Demand Transportation”, each of which provisional applications are hereby incorporated herein by reference in their respective entireties.

### BACKGROUND

Personal vehicles generally provide a flexible form of transportation for commuters and passengers within urban environments. However, in addition to being a more expensive option, passenger vehicles increase congestion and pollution. Public transit systems, including buses, trains, subways, etc., that operate on a fixed schedule, are an alternate lower cost option for commuters. Shared transportation options reduce in-city congestion and improve air quality. However, a public transit commuter may have less flexibility in terms of departure and arrival times.

Another shared transportation option that provides a good mix of flexibility, cost, ease of use, and environmental impact is an on-demand transportation service. For example, an on-demand bus service may operate along a route that is adjusted based on commuters requesting the service. Therein, a group of commuters from a common origin, or origins that are proximate to each other, may request to be transported to a common destination, or destinations proximate to each other. The shared ride reduces their commute cost while also reducing in-city congestion and pollution. At the same time, the schedule and route is determined by the commuters, increasing flexibility.

However, there may be problems with such systems. Because the shared ride is determined by the number of users requesting a ride to a common destination or from a common origin at any given time, there may be situations where the occupancy of the on-demand bus or other shared transportation vehicle is low. Such situations reduce profit margins and discourage the shared ride service provider. In addition, as the number of shared riders drops, the cost benefit to the user also drops.

### SUMMARY OF THE DRAWINGS

FIG. 1 illustrates a high level flowchart of an example method 100 for scheduling an on-demand bus based on trip requests received from one or more commuters, e.g., in the central server.

FIG. 2 illustrates a process for increasing occupancy of an on-demand vehicle.

FIG. 3 illustrates an example of a process for learning of user parameters by a control server.

FIG. 4 illustrates a diagram of an exemplary usage scenario for using an on-demand transportation system.

FIG. 5 is a block diagram of an exemplary transportation system.

### DESCRIPTION

Increasing occupancy of a shared transportation vehicle can include scheduling a shared ride based on ride requests received from one or more commuters, the scheduled ride including a scheduled route and scheduled commuter pick-ups and drop-offs, and while on the scheduled ride, identifying one or more active non-riding users of the shared ride system within a threshold distance of the scheduled route, the non-riding users identified by querying a database of user profiles and sending targeted notifications to the non-riding users. The one or more active non-riding users are identified based on a match between the user profiles and the scheduled ride. The targeted notifications include a reduced fare, the fare determined based on each of the user profile, and a position of the user relative to a position of the transportation vehicle on the shared ride.

In this way, occupancy of an on-demand shared transportation can be dynamically increased. By selectively notifying commuters of scheduled trips that they may be interested in joining, participation in shared transportation is increased. By adding commuters to scheduled trip while a trip is being undertaken, the occupancy of the shared transportation is increased over a longer portion of the trip. As such, this reduces the operator's cost of providing the service, while at the same time, the increase in the number of people sharing the service reduces the per capita cost for each of the commuters on the service. By promoting the use of shared transportation, air quality and in-city congestion is decreased while providing commuters with sufficient travel flexibility.

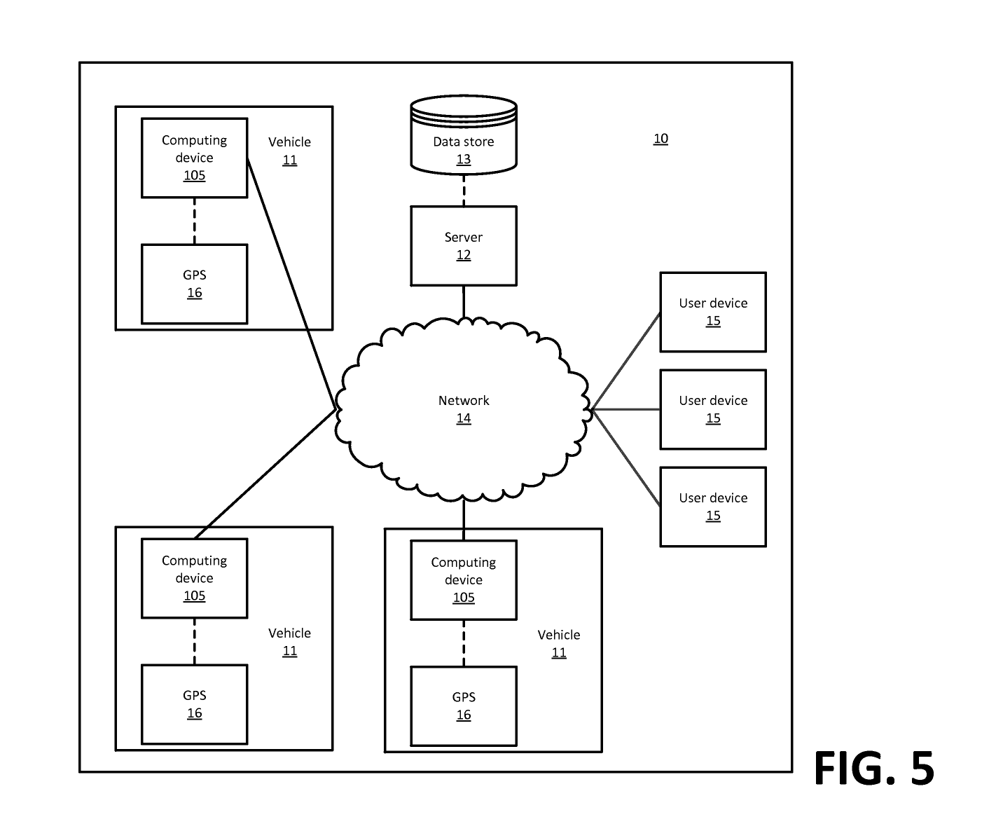

As described herein, including the accompanying drawings, in a shared transportation system 10 (see FIG. 5), an occupancy rate of a shared transportation vehicle 11, e.g., a bus or the like, can be improved by providing targeted advertisements to frequent users of an on-demand transportation, e.g., bus, service. For example, commuters may operate a mobile application or the like pertaining to the on-demand transportation service on a mobile device 15, such as a smart phone. The mobile application may, in turn, provide information to a server 12 of the on-demand bus service, e.g., a remote central server 12 accessible via a network 14 such as the Internet and/or other wide area network, as to the location of the commuter in relation to on-demand buses 11 currently on the roads.

In addition, settings and preferences for each commuter may be learned. These may include, for example, locations where the commuter tends to request a pick-up from, locations where the commuter tends to request a drop-off to, pick-up time and drop-off time preferences (e.g., time of day, day of week, etc.), as well as routes that the user tends to request (e.g., through certain neighborhoods or while avoiding certain neighborhoods). An on-demand bus may be operating a route based on pick-up and drop-off requests from a group of commuters. Based on the operated route being traveled on, the application may identify one or more commuters along the route, and in the vicinity of the bus, e.g., within a predetermined radius of 500 meters, a kilometer, three kilometers, etc., who might be interested in taking the bus. As such, these may be commuters who have not yet requested to be on the on-demand bus but who might have used the service previously. The application may then send targeted notifications to the one or more commuters advertising reduced fares to encourage them to use the on-demand bus service.

In this way, occupancy of an on-demand shared transportation can be improved. By selectively making commuters aware of the availability of an on-demand bus in their vicinity, commuters may be urged to make better use of the service. By increasing the occupancy of the bus, the bus service provider is able to improve its operational costs. At the same time, the bus service recipient is able to complete his or her commute more efficiently, e.g., at a lower cost.

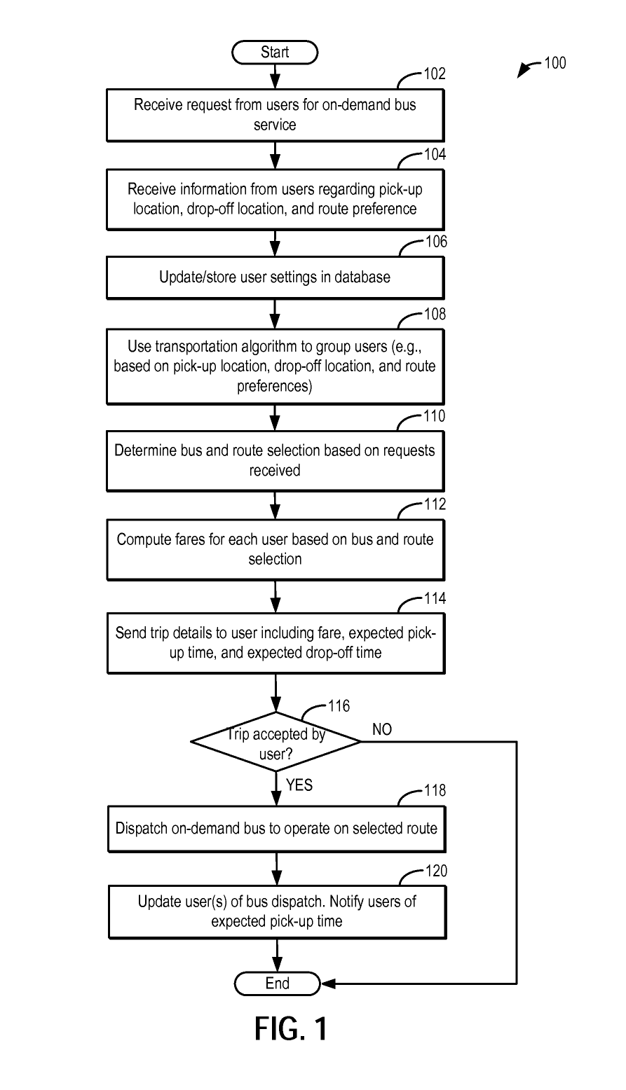

FIG. 1 illustrates a high level flowchart of an example process 100 for scheduling an on-demand bus based on trip requests received from one or more commuters, e.g., in the central server.

The process 100 begins at a block 102, in which requests are received at an on-demand bus service controller. e.g., in the server 12 via the network 14, from one or more mobile devices 15 such as may be operated by users who are commuting. In one example, the user may request a trip via the on-demand bus service through an application running on the user's smartphone device 15, the application communicatively coupling the user's smartphone to the control server 12.

Next, at 104, parameters for a trip request is received in the server 12 from one or more user devices 15, e.g., via the network 14. Example parameters include information pertaining to a pick-up location, a pick-up time (or time range), a drop-off location, a drop-off time (or time range), as well as route preferences specified by the user. The route preferences may include, as non-limiting examples, roads, streets, highways, and neighborhoods that the user would like the on-demand bus service to go through, or avoid.

Next, at 106, the user settings and preferences are stored in a database 13 included in or communicatively coupled to, the server 12, the settings and preferences being part of a user's profile.

Next, at 108, users are grouped based on their requests and preferences. For example, the server 12 may group users requesting to be picked up from locations that are proximate to each other, and/or requesting to be dropped off to locations that are proximate to each other. As another example, the server 12 may alternatively or additionally group users based on routing preferences.

Next, at 110, the server 12 selects a vehicle 11, and determines a trip route for the selected vehicle 11, based on the requests that were received. For example, the server 12 may plan a trip route based on the user grouping. In addition, the server 12 may select the size or other parameters of the vehicle 11 based on the number of commuters for that grouping. As an example, if the group size for a given route is smaller, a van or an automobile (e.g., sedan) vehicle 11 may be used instead of a full-sized city bus vehicle 11.

Next, at 112, fares are computed for each user based on the selected vehicle 11 and route. For example, fares may be calculated based on a distance to be traveled between the user's point of pick-up and point of drop-off, the fare increased as the distance increases. The fare may then be further adjusted based on a number of commuters sharing the vehicle 11 ride with the user. For example, as a number of commuters sharing a given on-demand vehicle 11 service along a specific route increases, the fare of the given route for each commuter on the given route may be decreased.

Next, at 114, trip details are sent to the user device 15. For example, a notification may be sent to the user via the application on the user's smartphone device 15 as to the fare details, the expected pick-up time, the expected drop-off time, etc. In addition, the user may be asked if the user would like to accept the trip.

Next, at 116, the server 12 may determine if the user has accepted the trip. For example, it may be determined if the user has accepted via the smartphone device 15 according to a communication received therefrom in the server 12. As such, if the user accepts the trip, the user may also thus accept to pay the fare for the requested on-demand vehicle 11 service. If the user does not accept the trip, the process 100 may end at the block 116.

At 118, following 116, if the user does accept the trip, the server 12 may dispatch the on-demand vehicle 11 to operate on the determined route.

Next, at 120, the server 12 may also notify the user device 15 that the vehicle 11 has been dispatched, and a pick-up time may be displayed to the user via the application on the device 15. For example, the display may provide a countdown to the time when the vehicle 11 will pick up the user. In further examples, the display may provide a location of the vehicle 11 on a map, the planned route, a real time location of the bus along the route, as well as the user's position along the route.

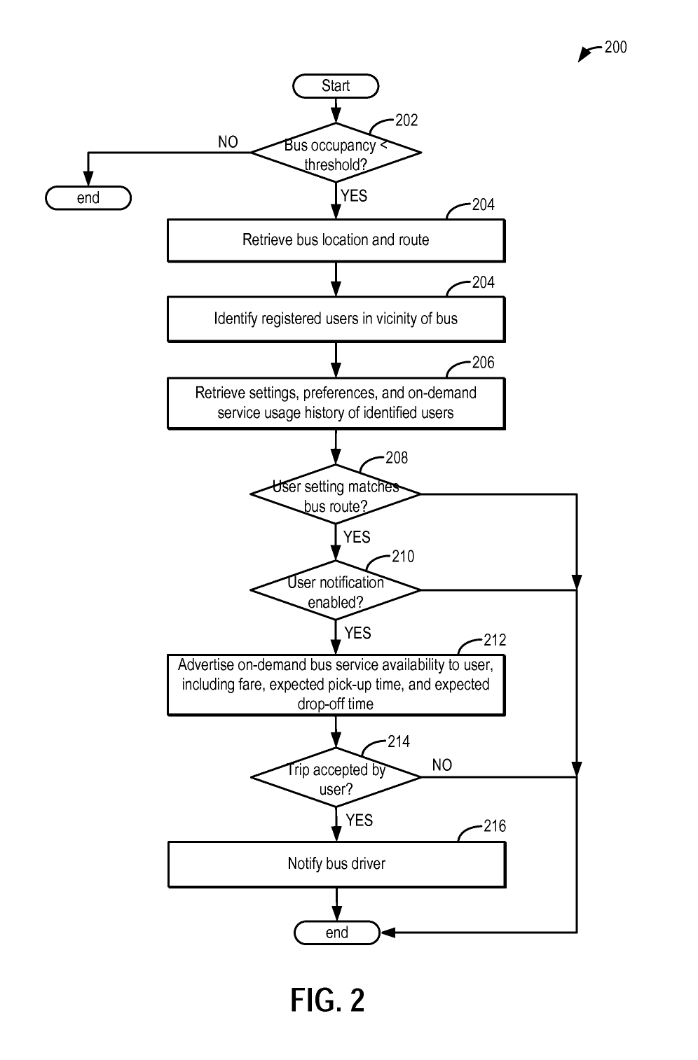

FIG. 2 illustrates a high level flow chart of a method 200 for increasing the occupancy of an on-demand vehicle 11 travelling along a determined route by providing targeted advertisements in real time to commuters in the vicinity of the vehicle 11, or along the route of the vehicle 11. Steps of the method 200 may be carried out by the central server 12.

The process 200 begins at a block, 202, wherein the server 12 may confirm that the bus occupancy of a vehicle 11 is lower than a predetermined threshold. For example, the threshold may be established according to an occupancy desired to achieve or improve to improve on-demand vehicle 11 service profitability. If the occupancy is not lower than the predetermined threshold, the process 200 may end following the block 202.

However, if an increase in occupancy is desired. i.e., the occupancy is lower than the predetermined threshold in the block 202, then at 204, a location and route of each vehicle 11 of the system 10 may be retrieved. In one example, such data may be retrieved via a program running in a computing device 105 included in the vehicle 11, the computer 105 communicatively coupled to the server 12, e.g., via the network 14.

Next, at 206, the server 12 may identify one or more registered users in the vicinity of the vehicle 11. e.g., according to a predetermined radius such as mentioned above, a predetermined area, etc. As such, these registered users may be commuters who have previously used the on-demand bus service, but who are not commuting on the on-demand bus currently. A registered user may be identified based on communication between the application running on the user's smart phone device 15 and the central server 12. The server 12 may identify users located within a threshold radius of the vehicle 11 being routed on a trip. Further, users who are located along a scheduled route of the vehicle 11 may be identified, e.g., according to identifiers provided from users' respective devices 15.

Next, at 208, user parameters, e.g., settings, preferences, and on-demand system 10 usage history of each of the identified users may be retrieved. For example, details regarding pick-up points, drop-off points, and routes commonly used by the user when requesting a trip via the system 10 may be retrieved. As another example, details regarding how often the user has requested to use the system 10, when the user tends to take trips (time of day, day of week), distance covered on average on each trip, etc., may be retrieved from the server 12 database 13.

Next, at 210, it may be determined whether any of the user parameters match the settings of the scheduled vehicle 11 trip. For example, it may be determined whether the scheduled route of the on-demand vehicle 11 at least partially overlaps a route commonly requested by a user. As another example, it may be determined if a user is likely to go to a destination that is along the planned route of the vehicle 11. If user parameters do not match the parameters of the vehicle 11 trip, the process 200 may end.

However, if user parameters meet parameters of the scheduled trip, at 212, the server 12 may determine whether user notification is enabled. In one example, a user may have notification settings enabled on the application running on a smartphone device 15. The notification settings may specify whether the user wishes to be notified about any on-demand vehicle 11 options available around him or her, as well as whether the user wishes to be selectively notified when travelling in specified locations and/or at specified times. For example, the user may wish to be notified about trip options only when in areas that have infrequent public transit service. As another example, the user may wish to be notified about trip options only during times (e.g., early morning, evenings, weekends) when public transit service is infrequent or less reliable. As still another example, the user may wish to receive notifications for selected routes only. In still other examples, the user may have notifications enabled by default.

If notification is not enabled, the routine 200 may end following the block 212. The process 200 may then be reinitiated when the a device 15 notification is enabled again.

If user device 15 notification is enabled, then at 214, the server 12 provides a notification message concerning the on-demand vehicle 11 availability to the user device 15. The notification message may include an advertised fare, expected pick-up time and location, expected drop-off time and location, bus route, etc. The notification message may be provided as a text message (e.g., using short message service or the like), or a pop-up chat message on the application running in the user's smartphone device 15.

Next, at 216, it is determined if the user has accepted the trip. In one example, in addition to the notification message, YES and NO buttons or the like may be provided in a display of a device 15 to allow the user to accept or reject the offer. For example, a user may accept an offer by selecting a YES button. Typically, once the user accepts the trip offer, the user accepts to pay the fare and abide by all related fare rules. In some examples, where the user profile includes a user payment profile, a fare transaction may be completed when the user accepts the trip and the user may be provided with an electronic ticket for the trip. If the user does not accept the trip offer, the process 200 may end. Additionally, the server 12 may update the user's history in the database 13, and may further be programmed to use such data to learn trips that the user did or did not accept and to thereby better provide offers to the user in the future.

Once the trip is accepted by the user, at 218, the server 12 may notify the driver of the on-demand bus service, e.g., via a human machine interface or the like of a computer 105, so that the trip can accordingly adjusted to pick up the added commuter. The user may also be updated, in real time, of the location of the bus in relation to the pick-up location via the user's device 15.

It will be appreciated that while the example process 200 suggests selectively sending notifications to user devices 15 in the vicinity of an on-demand vehicle 11 based on occupancy estimates, in alternate examples, the routine 200 may be performed each time an on-demand vehicle 11 trip is scheduled to optimize occupancy.

In this way, the occupancy of vehicles 11 in the system 11 may be increased even after a vehicle 11 has departed on its scheduled route by adding on commuters dynamically via targeted advertisements.

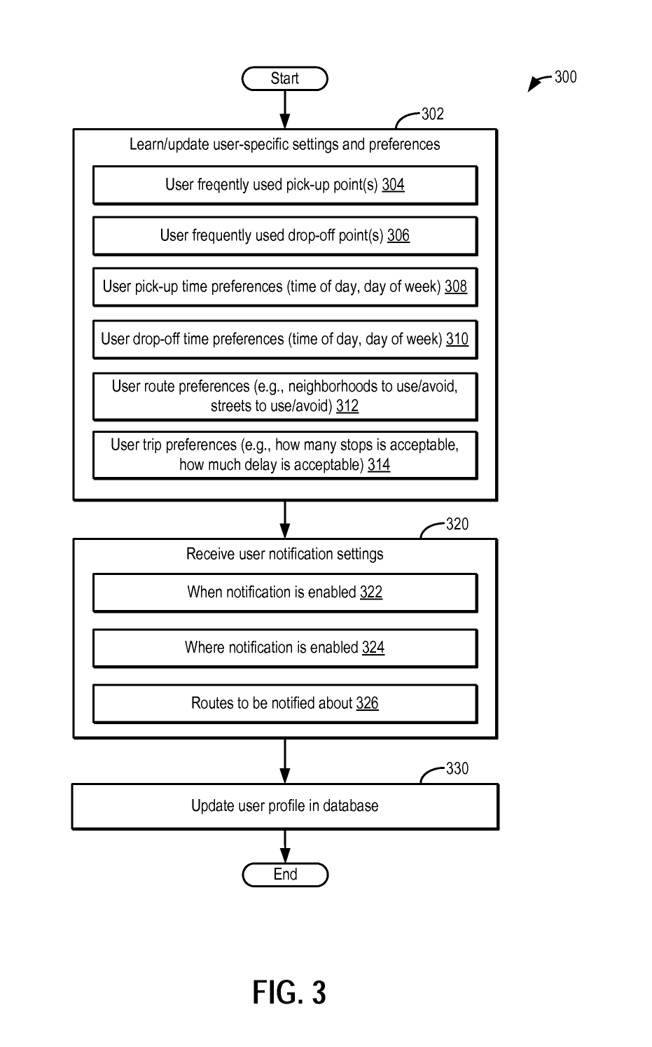

Turning now to FIG. 3, an example method 300 is shown for learning of user parameters by the control server 12 in conjunction with a device 15. For example, such learning may be performed via data gathered by an application running on a user's mobile device 15, such as on a smartphone.

The process 300 begins in a block 302, in which user-specific parameters. e.g., settings and preferences, may be learned and stored in a user's profile maintained in a memory of the device 15. For example, the learning and updating may be performed each time a user requests a trip, accepts a trip, or responds to a trip notification. The user-specific settings and preferences learned may include, for example pick-up points commonly used by the user at 304, and drop-off points common used by the user at 306. The pick-up points may be learned as a function of distance from the user's likely point of origin (e.g., as a function of distance from home when commuting to work from home) or from the user's likely destination (e.g., as a function of distance from place of work when commuting from work to home). The learning further includes learning user pick-up time preferences (at 308) and drop-off time preferences (at 310). These may include, for example, a time of day as well as a day of week. In addition, pick-up points also be learned as a function of pick-up time and drop-off points may be learned as a function of drop-off time. At 312, route preferences may be learned, such as neighborhoods or streets the user prefers to be driven through, as well as neighborhoods and streets the user prefers to avoid on his trip. At 314, the user's trip preferences may be learned, such as how many stops on the on-demand bus service is acceptable to the user, how long of a delay is the user willing to accept with regard to a pick-up time before the user opts to cancel the service. Still other trip features may be learned.

At 320, user notification settings are learned and included as part of the user's profile. These include settings selected by the user that determine whether they wish to receive notifications about on-demand bus services in their vicinity. As discussed with respect to FIG. 2, the settings may specify when notification is to be enabled at 322. For example, the user may select notification enablement during commute times (e.g., before 9 am, and after 5 pm) and disable notification enablement during office hours (e.g., between 9 am and 5 pm). As another example, the user may select notification enablement on weekdays and disable notification enablement during weekends. At 324, the user selected settings may specify where notification is to be enabled. For example, the user may opt to be notified only in areas where public transit service is infrequent. At 326, the settings may specify which routes the user wishes to be notified about. As an example, the user may opt to be notified about vacancies only on selected routes.

At 320, the learned user settings and preferences may be used to update the user profile, including by transmitting information for the user to the server 12 for storage in the data store 13. By using the settings of the user profile to send targeted advertisements to the user, shared transportation occupancy can be improved without inconveniencing the user with unwanted notifications.

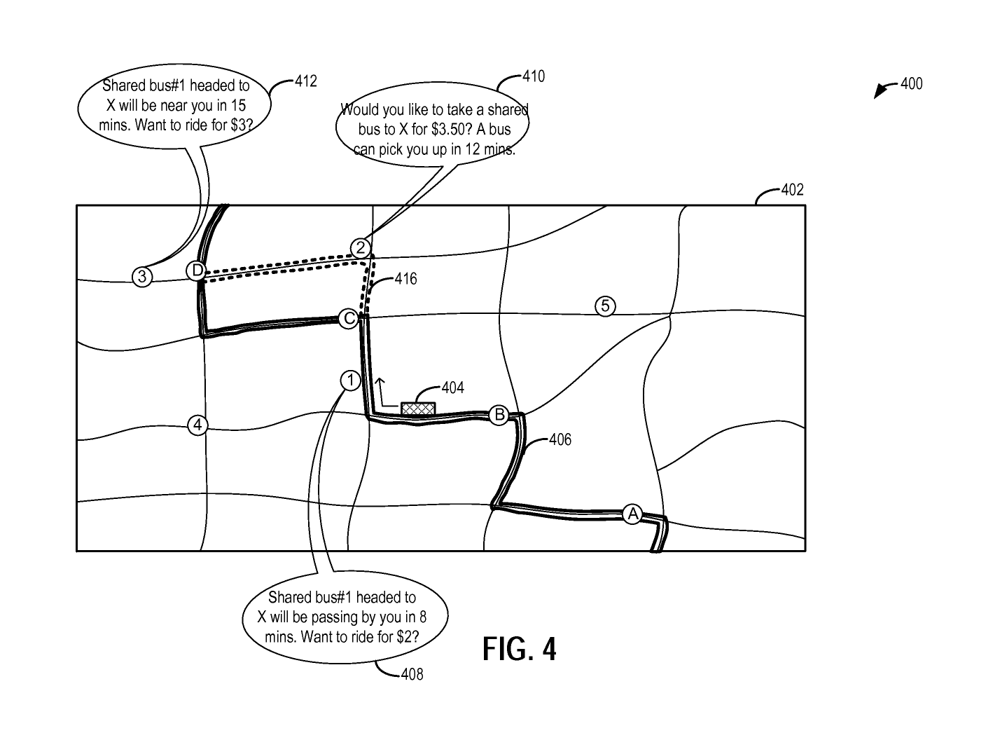

FIG. 4 illustrates a diagram of an exemplary usage scenario 400 for using an on-demand transportation system 10. In the depicted example, a region where an on-demand bus service according to the system 10 is being provided is shown at map 402 wherein the thin lines depict roads and cross roads. An on-demand bus service is scheduled for bus 404 along route 406 (depicted by thickened lines). The scheduled bus trip includes the scheduled pick-up of commuters A-D. In the depicted example, a time point is shown when the bus has already picking up commuters A and B, and is enroute to picking up commuter C.

It may be determined that users 1-5 are in the vicinity of bus 404 while on route 406. Users 1-5 may have previously used this bus service and based on their user settings, it may be determined that the users may be headed in the same direction as bus route 406. Of the users, user 1 is identified to be along the route and closest to the current location of the bus. In other words, no detour would be required to pick up user 1. Accordingly, a notification 408 is sent to user 1 informing user 1 that shared bus #1 headed to destination X is about to pass in 8 minutes. In addition, a discounted fare of $2 is offered to user 1 to join the trip.

An alternate notification 410 is sent to user 2. User 2 is determined to be in the general vicinity of the scheduled bus route but not exactly along the route. However, based on the map, it is determined that user 2 can be picked up after commuter C and then a minor detour 416 can be used to pick up user 2 before heading to pick up commuter D. As such, detour 416 would either not lead to a significant delay in the pick-up of commuter D, or the delay may be within the acceptable delay margin of the commuter D. Accordingly, a notification 410 is sent to user 2 informing them that shared bus #1 headed to destination X is headed in user 2's direction in 10 minutes, and the user is offered a ride for a discounted fare of $3.50. Herein, the higher fare for user 2 as compared to user 1 factors in the detour required in the pick-up of user 2 as compared to no detour required in the pick-up of user 1.

Yet another notification 412 is sent to user 3. User 3 is determined to be further along the route, and potentially close to the pick-up location of commuter D. Accordingly, a notification 412 is sent to user 3 informing them that shared bus #1 headed to destination X is about to pass user 3 in 15 minutes. In addition, a discounted fare of $3 is offered to them to join the trip.

In the illustrated example, no targeted notifications are sent to users 4 and 5 despite their being in the vicinity of the bus. This may be, for example, due to their location being such that a significant detour would be required in their pick-up, causing delays in the pick-up or drop-off of the scheduled commuters. Alternatively, their settings may indicate that they do not prefer to be notified about this particular route.

It will be appreciated that still other users may be present in the vicinity of bus 404 but they may not be notified due to their preferred direction of travel not matching route 406.

FIG. 5 is a block diagram of an exemplary transportation system 10 that includes at least one, and typically a plurality, of vehicles 11, e.g., a public transportation vehicle such as a bus, van, etc. Each vehicle 11 includes a computer 105 communicatively coupled with a network 14. The vehicle 11 may further include a global positioning system (GPS) device 16 or the like in a vehicle 101.

A vehicle 11 computer 105 may be configured for communications on a controller area network (CAN) bus or the like, and/or other wire or wireless protocols, e.g., Bluetooth, etc., i.e., the computer can communicate via various mechanisms that may be provided in a vehicle 101, and can accordingly receive data from sensors, communications via the network 14, e.g., from the server 12, etc. The computer 105 may also have a connection to an onboard diagnostics connector (OBD-II). Via the CAN bus, OBD-II, and/or other wired or wireless mechanisms.

The network 14 represents one or more mechanisms by which a vehicle computer 105 may communicate with a remote server 12 and/or a user device 15. Accordingly, the network 14 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

The server 12 may be one or more computer servers, each generally including at least one processor and at least one memory, the memory storing instructions executable by the processor, including instructions for carrying out various steps and processes described herein. The server 12 may include or be communicatively coupled to the data store 13, as mentioned above, for storing data received from one or more vehicles 111.

The server 12, may be accessible via a network, and may be one or more computer servers, each generally including at least one processor and at least one memory, the memory storing instructions executable by the processor, including instructions for carrying out various of the steps and processes described herein. The network may include one or more mechanisms by which a vehicle computer may communicate with the remote server 12, and/or other vehicles, user devices such as a smartphone, etc. Accordingly, the network may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, IEEE 802.11, etc.), local area networks (LAN) and/or wide area networks (WAN), including the Internet, providing data communication services.

A user device 15 may be any one of a variety of computing devices including a processor and a memory, as well as communication capabilities. For example, the user device 15 may be a portable computer, tablet computer, a smart phone. etc. that includes capabilities for wireless communications using IEEE 802.11, Bluetooth, and/or cellular communications protocols. Further, the user device 15 may use such communication capabilities to communicate via the network 14 including with a vehicle computer 105. A user device 15 could communicate with a vehicle 11 computer 105 the other mechanisms, such as a network in the vehicle 101, a known protocols such as Bluetooth, etc. Further, a user device 15 could be used to provide a human machine interface (HMI) to the computer 105.

Computing devices such as those discussed herein generally each include instructions executable by one or more computing devices such as those identified above, and for carrying out blocks or steps of processes described above. Computer-executable instructions may be compiled or interpreted from computer programs created using a variety of programming languages and/or technologies, including, without limitation, and either alone or in combination. Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in a computing device is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

1. A system, comprising a computer including a processor and a memory, the memory storing instructions executable by the computer to:
detect a user in a vicinity of a shared transportation vehicle by identifying a user device and determining a location of the user device;
determine parameters for user travel of a route of the shared transportation vehicle, and target a message to a device of the detected user based on a location of the detected user.

2. The system of claim 1, wherein the parameters for user travel include at least one of frequent pick-up points, frequent drop-off points, frequent pick-up times, and frequent drop-off times.

3. The system of claim 1, wherein the computer is further configured to send the message to the user device.

4. The system of claim 3, wherein the computer is further configured to receive a response form the user device.

5. The system of claim 3, wherein the computer is further configured to send a second message to the shared transportation vehicle.

6. The system of claim 3, wherein the computer is further configured to determine that the user device has enabled notifications before sending the message.

7. The system of claim 1, wherein the computer is further configured to determine the route based at least in part of the user parameters.

8. A system comprising a computer including a processor and a memory, the memory storing instructions executable by the computer to:
detect a user in a vicinity of a shared transportation vehicle by identifying a user device and determining a location of the user device;
receive parameters relating to user travel;
determine a route of the shared transportation vehicle that encompasses the user travel, and
target a message to a device of the detected user concerning the route.

9. The system of claim 8, wherein the parameters for user travel include at least one of frequent pick-up points, frequent drop-off points, frequent pick-up times, and frequent drop-off times.

10. The system of claim 8, wherein the computer is further configured to send the message to the user device.

11. The system of claim 10, wherein the computer is further configured to receive a response form the user device.

12. The system of claim 10, wherein the computer is further configured to send a second message to the shared transportation vehicle.

13. The system of claim 10, wherein the computer is further configured to determine that the user device has enabled notifications before sending the message.

14. A method, comprising
detecting a user in a vicinity of a shared transportation vehicle by identifying a user device and determining a location of the user device;
determining parameters for user travel of a route of the shared transportation vehicle, and
targeting a message to a device of the detected user based on a location of the detected user.

15. The method of claim 14, wherein the parameters for user travel include at least one of frequent pick-up points, frequent drop-off points, frequent pick-up times, and frequent drop-off times.

16. The method of claim 14, further comprising sending the message to the user device.

17. The method of claim 16, further comprising receiving a response form the user device.

18. The method of claim 16, further comprising sending a second message to the shared transportation vehicle.

19. The method of claim 16, further comprising determining that the user device has enabled notifications before sending the message.

20. The method of claim 14, further comprising determining the route based at least in part of the user parameters.
